(19) United States
(12) Patent Application Publication
(10) Pub. No.: US 2008/0291194 A1
(43) Pub. Date: Nov. 27, 2008

(54) DATA TRANSMISSION METHOD APPLIED IN ASYNCHRONOUS DISPLAY AND RELATED ELECTRONIC SYSTEM

(76) Inventors: Yung-Ching Lee, Taoyuan County (TW); Huai-Te Hsu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/752,923

(22) Filed: May 23, 2007

(51) Int. Cl. G09G 5/00; G06F 3/038

(52) U.S. Cl. 345/213

(57) ABSTRACT

An electronic system including a display device, a microcontroller unit (MCU), and a display driver is disclosed. The MCU controls the operations of the electronic system. The display driver drives the display device according to the control of the MCU. The MCU and the display driver are interconnected by a mode selection line, a reference clock line, and a data transmission line set. The MCU informs the display driver of a current transmission mode through the mode selection line and transmits a reference clock to the display driver through the reference clock line. The MCU and the display driver synchronize data transmitted through the data transmission line set according to the reference clock.

### BACKGROUND OF THE INVENTION

1. Field of the Invention

The invention relates to asynchronous display, and more particularly, to a data transmission method applied in an asynchronous display and a related electronic system.

2. Description of the Prior Art

In general, display devices can be separated into two types according to different application schemes, namely, synchronous display devices and asynchronous display devices. In synchronous display devices, the display drivers of the synchronous display devices have to receive frame data with fixed frame refresh rates to drive the synchronous display devices accordingly. For example, when a frame refresh rate is 60 Hz, the display drivers of the synchronous display devices have to receive data of sixty frames per second whether the required display frames have different contents or not. Display devices such as computer display devices and LDC TVs, etc all belong to synchronous display devices. For asynchronous display devices, the display drivers do not perform driving tasks according to frame data with fixed frame refresh rates. For example, when the required display frames are all the same, the display drivers of the asynchronous display devices can perform driving tasks according to data stored in memory units of the asynchronous display devices directly, and the display drivers do not have to receive the repeat frame data. Only when the required display frames have different contents do the display drivers of the asynchronous display devices have to receive new frame data to drive the asynchronous display devices accordingly. The display devices disposed in MP3 players, printers, and electronic photo frames, etc can belong to the asynchronous display devices.

For electronic systems including the asynchronous display devices, microcontroller units (MCU) of the electronic systems are generally dependant on conventional data transmission interfaces (such as GPIO) as the transmission interface between the MCU and the display driver of the asynchronous display device. However, all of the conventional data transmission interfaces have a disadvantage of lower transmission speed, and therefore bandwidth provided for image data transmission is usually restricted. Furthermore, all of the conventional data transmission interfaces have a characteristic of having complex interfaces, and therefore the conventional data transmission interfaces often occupy a large number of I/O pins of the MCU. For the MCU integrating multi-functions, the number of I/O pins provided by the MCU is usually restricted, and it is not certain that the MCU can provide enough I/O pins for the asynchronous image data transmission.

### SUMMARY OF THE INVENTION

It is therefore one of the objectives of the present invention to provide a data transmission method applied in an asynchronous display and a related electronic system.

According to an embodiment of the present invention, an electronic system is disclosed. The electronic system includes a display device, a microcontroller unit (MCU), and a display driver. The MCU controls the operations of the electronic system. The display driver drives the display device according to control of the MCU. The MCU and the display driver are interconnected by a mode selection line, a reference clock line, and a data transmission line set. The MCU informs the display driver of a current transmission mode through the mode selection line and transmits a reference clock to the display driver through the reference clock line. The MCU and the display driver synchronize data transmitted through the data transmission line set according to the reference clock.

According to an embodiment of the present invention, a data transmission method for letting an MCU and a display driver communicate where the display driver is utilized for driving a display device according to control of the MCU is further disclosed. The method includes the MCU informing the display driver of a current transmission mode; the MCU transmitting a reference clock to the display driver; and the MCU and the display driver synchronizing according to the reference clock to perform communication.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an electronic system according to an embodiment of the present invention.

FIG. 2 shows an example of a timing diagram of a signal transmitting between the MCU and the display driver shown in FIG. 1 under a register access mode.

FIG. 3 and FIG. 4 show two examples of a timing diagram of a signal transmitting between the MCU and the display driver shown in FIG. 1 under a data transmission mode.

### DETAILED DESCRIPTION

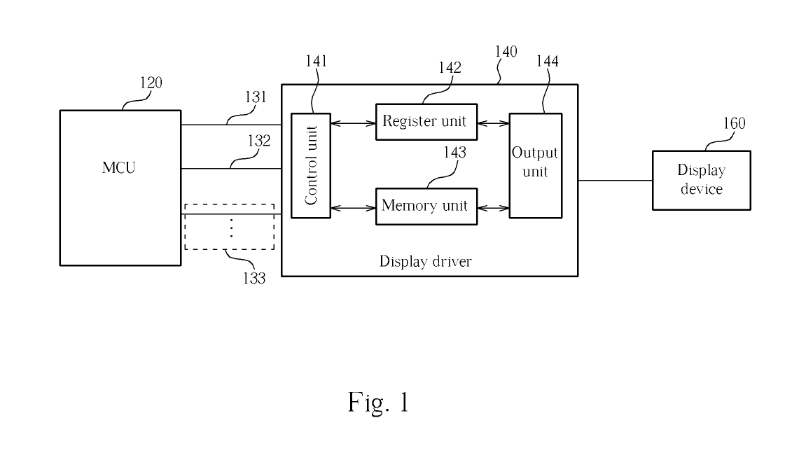

FIG. 1 shows an electronic system according to an embodiment of the present invention. The electronic system 1 00 of the present invention includes a microcontroller unit (MCU) 120, a display driver 140, and a display device 160. The MCU 120 controls the operations of the electronic system 100. The display driver 140 drives the display device 160 according to the control of the MCU 120. The display driver 140 includes a control unit 141, a register unit 142, a memory unit 143, and an output unit 144. The control unit 141 controls the operations of the display driver 140. The register unit 142 stores an operation setting value of the display driver 140. The memory unit 143 stores frame data of the display driver 140 of the memory unit 143 for driving the display device 160. In the electronic system 100, since the display device 160 is utilized as an asynchronous display device, the display driver 140 does not need to receive frame data with fixed frame refresh rates from the MCU 120.

In this embodiment, the MCU 120 and the display driver 140 are interconnected by a mode selection line 131, a reference clock line 132, and a data transmission line set 133, wherein the data transmission line set 133 can include one or a plurality of data transmission lines. The reference clock line 132 allows the MCU 120 to transmit a reference clock RCK to the display driver 140, and the MCU 120 and the display driver 140 can utilize the reference clock RCK as a basis of synchronizing transmission. The mode selection line 131 allows the MCU 120 to transmit a mode selection signal MS to the display driver 140, in order to inform the display driver 140 what a current transmission mode is. For example, when the MCU 120 sets the mode selection signal MS as a first mode (such as a low potential mode), it means that the current transmission mode is a register access mode, and the MCU 120 can control the display driver 140 via one or a plurality of data transmission lines in the data transmission line set 133 to access the register unit 142. When the MCU 120 sets the mode selection signal MS as a second mode (such as a high potential mode), it means that the current transmission mode is a data transmission mode, and the MCU 120 can control the display driver 140 via one or a plurality of data transmission lines in the data transmission line set 133 to access the memory unit 143.

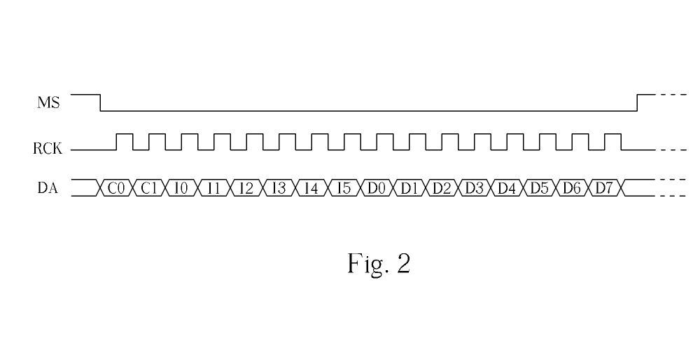

FIG. 2 shows an example of a timing diagram of a signal transmitting between the MCU 120 and the display driver 140 under the register access mode. In this example, only one data transmission line in the data transmission line set 133 is utilized to transmit a data signal DA, wherein C0˜Cm in the data signal DA are command codes, I0˜In are target register addresses, and D0˜Dp are setting values. The above-mentioned m, n, and p can be equal to any positive integer such as 1, 5, and 7 respectively, but not limited to these integers. When C0˜Cm correspond to a writing command, D0˜Dp are the setting values transmitted by the MCU 120 to the display driver 140, and the display driver 140 will write D0˜Dp into the target register addresses in the register unit 142 indicated by I0˜In. When C0˜Cm correspond to a reading command, the display driver 140 will read the setting values D0˜Dp from the target register addresses in the register unit 142 indicated by I0˜n, and transmit the setting values D0˜Dp to the MCU 120 via the data signal DA. Please note that although only one data transmission line in the data transmission line set 133 is utilized to transmit the data signal DA in this example, if the data transmission speed under the register access mode is required to be increased, a plurality of data transmission lines in the data transmission line set 133 can also be utilized to transmit a plurality of data signals (of course, the number of the utilized data transmission lines must be less than the total number of the utilized data transmission lines in the data transmission line set 133).

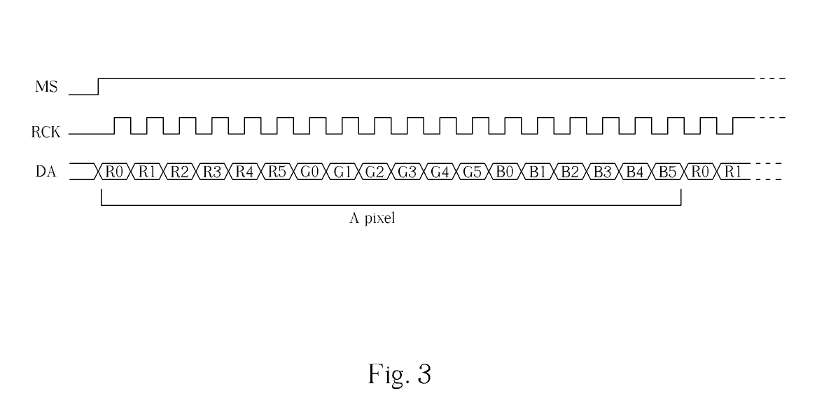

FIG. 3 shows an example of a timing diagram of a signal transmitting between the MCU 120 and the display driver 140 under the data transmission mode. In this example, only one data transmission line in the data transmission line set 133 is utilized to transmit a data signal DA, and the data signal DA can include data that the MCU 120 controls the display driver 140 to write into the memory unit 143, or data that the MCU 120 controls the display driver 140 to read from the memory unit 143. When the MCU 120 transmits a burst accessing command via the data signal DA, and after the MCU 120 sets the mode selection signal MS as the second mode, the MCU 120 and the display driver 140 can transmit a great number of pixel signals continuously via the data signal DA. Taking the display device 160 being a 6-bit panel as an example, a pixel can be transmitted via the data signal DA each time through eighteen clock cycles of the reference clock RCK.

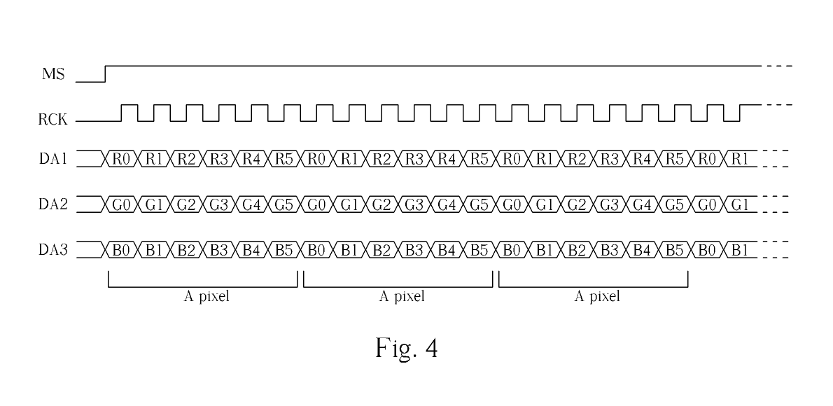

FIG. 4 shows another example of a timing diagram of a signal transmitting between the MCU 120 and the display driver 140 under the data transmission mode. In this example, three data transmission lines in the data transmission line set 133 are utilized to transmit data signals DA1, DA2, and DA3, and the data signals DA1 DA3 can include data that the MCU 120 controls the display driver 140 to write into the memory unit 143, or data that the MCU 120 controls the display driver 140 to read from the memory unit 143. When the MCU 120 transmits a burst accessing command via the data signals DA1 DA3, and after the MCU 120 sets the mode selection signal MS as the second mode, the MCU 120 and the display driver 140 can transmit a great number of pixel signals continuously via the data signals DA1 DA3. Taking the display device 160 being a 6-bit panel as an example, a pixel can be transmitted via the data signals DA1 DA3 each time through six clock cycles of the reference clock RCK.

Advantages of the above embodiments are that the utilized asynchronous display transmission interface (including the mode selection line 131, the reference clock line 132, and the data transmission line set 133) is quite simple, and the number of the included connection lines can be flexible, i.e. the number of the data transmission lines included by the data transmission line set 133 can be determined according to the operation requirement and resource configuration of the electronic system 100. For example, if the number of I/O pins provided by the MCU 120 for the asynchronous display transmission is restricted, than the data transmission line set 133 can include less data transmission lines. If a higher bandwidth requirement for the asynchronous display transmission occurs, than the data transmission line set 133 can include more data transmission lines.

Additionally, the asynchronous display transmission interface of the above embodiments can provide a relatively high transmission speed. Taking the timing diagram shown in FIG. 4 for example, a pixel required by the 6-bit panel can be transmitted via the data signals DA1 DA3 each time through six clock cycles of the reference clock RCK.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic system, comprising:
a display device;
a microcontroller unit (MCU), for controlling operations of the electronic system; and
a display driver, coupled to the MCU and the display device, for driving the display device under control of the MCU;
wherein the MCU and the display driver are interconnected by a mode selection line, a reference clock line, and a data transmission line set, the MCU informs the display driver of a current transmission mode through the mode selection line and transmits a reference clock to the display driver through the reference clock line, and the MCU and the display driver synchronize data transmitted through the data transmission line set according to the reference clock.

2. The electronic system of claim 1, wherein the display driver comprises a register unit for storing an operation setting value of the display driver, and the MCU controls the display driver via the data transmission line set to make the display driver access the register unit when the current transmission mode is a register access mode.

3. The electronic system of claim 1, wherein the display driver comprises a memory unit for storing frame data of the display driver utilized for driving the display device, and the MCU controls the display driver via the data transmission line set to make the display driver access the memory unit when the current transmission mode is a data transmission mode.

4. The electronic system of claim 1, wherein the display device is an asynchronous display device.

5. The electronic system of claim 1, wherein the MCU does not transmit frame data to the display driver with a fixed frame refresh rate.

6. A data transmission method, for letting an MCU communicate with a display driver, the display driver utilized for driving a display device according to control of the MCU, the method comprising:
the MCU informing the display driver of a current transmission mode;
the MCU transmitting a reference clock to the display driver; and
the MCU and the display driver utilizing the reference clock to synchronize a communication therebetween.

7. The data transmission method of claim 6, wherein the MCU and the display driver are interconnected by a mode selection line, a reference clock line, and a data transmission line set, the MCU informs the display driver of the current transmission mode through the mode selection line and transmits the reference clock to the display driver through the reference clock line, and the MCU and the display driver synchronize data transmitted through the data transmission line set according to the reference clock.

8. The data transmission method of claim 6, wherein the step of the MCU and the display driver utilizing the reference clock to synchronize the communication therebetween comprises:
the MCU controlling the display driver via the data transmission line set to make the display driver access a register unit of the display driver when the current transmission mode is a register access mode.

9. The data transmission method of claim 6, wherein the step of the MCU and the display driver utilizing the reference clock to synchronize the communication therebetween comprises:
the MCU controlling the display driver via the data transmission line set to make the display driver access a memory unit of the display driver when the current transmission mode is a data transmission mode.

10. The data transmission method of claim 6, wherein the display device is an asynchronous display device.

11. The data transmission method of claim 6, wherein the MCU does not transmit frame data to the display driver with a fixed frame refresh rate.
